(19) United States
(12) Patent Application Publication
(10) Pub. No.: US 2026/0304360 A1
(43) Pub. Date: Oct. 1, 2026

(54) METHODS AND UNMANNED AERIAL VEHICLES FOR POSITIONING A RADIO ANTENNA

(71) Applicant: Telefonaktiebolaget LM Ericsson (publ), Stockholm (SE)

(72) Inventors: Mohammad Reza GHOLAMI, STOCKHOLM (SE); Göran ERIKSSON, NORRTÄLJE (SE)

(21) Appl. No.: 19/480,843

(22) PCT Filed: May 5, 2023
(86) PCT No.: PCT/SE2023/050441

§ 371 Date: Nov. 3, 2025

(51) Int. Cl. H04W 64/00; H04B 17/318; H04W 84/06

(52) U.S. Cl. CPC H04W 64/00; H04B 17/318; H04W 84/06

(57) ABSTRACT

A method performed by an unmanned aerial vehicle, UAV (110), the method being used for positioning a radio antenna (118), the method comprises: performing (204), while flying (202) within a sector (120), at one or more positions, signal strength measurements (314, 316) of radio signal emitted from the radio antenna (118); if an average of the signal strength measurements (314, 316) is above an average signal strength measurement threshold, performing (222) position measurements of the radio antenna (118); and if the average of the signal strength measurements (314, 316) is below the average signal strength measurement threshold, repeating the method for an updated sector (122), wherein the updated sector (122) is based on one or more of the signal strength measurements (314, 316).

### TECHNICAL FIELD

The present disclosure relates generally to methods and unmanned aerial vehicles (UAVs) for positioning a radio antenna. The present disclosure also relates to computer programs and carriers corresponding to the above methods and UAVs.

### BACKGROUND

Radio antennas are central parts of a wireless communication network. Both network side equipment, such as base station, gNodeB, eNodeB, and user equipment (UE) are equipped with radio antennas. Furthermore, radio antennas can be equipped on other objects, e.g., vehicles, sensors, identification/positioning tags on physical objects, chips, infrastructures, etc. In general, objects capable of radio communication should be equipped with radio antennas.

The positions and directions of the radio antennas are important data to optimize coverage and capacity of the radio network related to the radio antennas. The positions and directions of the radio antennas are fundamental aspects for providing users with high quality connectivity services. Specifically, when a new radio antenna is mounted, the radio antenna position and direction is used when allocating a signal carrier frequency to it. In some scenarios, the radio antenna is in the same position as radio unit (RU) of the radio network. In other scenarios, the radio antenna is far away from the RU. For example, the radio antenna may be located 100 meters away from the RU. Therefore, the actual position of the radio antenna needs to be determined correctly and accurately. Besides, a radio antenna can also be equipped in other devices/objects, e.g., user equipment (UE), vehicles, etc. It is also important to determine an accurate position of such radio antenna.

In prior art, some radio antennas may be equipped with a Global Positioning System (GPS) receiver. However, since the GPS receiver increases the cost for a radio antenna, not all radio antennas are equipped with the GPS receiver. Furthermore, the GPS receiver may be attacked by a malicious agent, or has an inaccurate position estimation, when the radio antenna is located in a position where the GPS satellite access is limited.

For those radio antennas which are not equipped with GPS receiver, a human field engineer may be assigned to find the actual position of the radio antenna. However, assigning a human engineer increases cost for the whole system. Especially when the radio antenna position changes, e.g., tilts or suffers from deliberate malign actions or vandalism, the human engineer needs to be assigned again to determine the new position of the radio antenna. This arrangement further increases the cost.

Another method is to use UEs, which wirelessly connect to the target radio antenna, to collect radio signal strength or other types of measurements, and to estimate the radio antenna position based on UE positions and collected measurements. However, this method requires the UEs to reveal their positions and needs UE user's consent. When some of the users do not agree to reveal their UE positions, the position estimation of the radio antenna may be inaccurate.

In conclusion, the methods for estimating radio antenna positions in prior art have some disadvantages. There is a need to provide an automatic, economic and accurate solution for estimating the position of radio antennas.

### SUMMARY

It is an object of the invention to address at least some of the problems and issues outlined above. It is an object of embodiments of the invention to position radio antenna automatically without dispatching a human engineer. It is another object of embodiments of the invention to position radio antenna accurately. It is possible to achieve one or more of these objects and possibly others by using methods and UAVs as defined in the attached independent claims.

According to an embodiment, a method performed by an UAV is disclosed. The method is used for positioning a radio antenna, the method comprises: performing, while flying within a sector, at one or more positions, signal strength measurements of radio signal emitted from the radio antenna; if an average of the signal strength measurements is above an average signal strength measurement threshold, performing position measurements of the radio antenna; and if the average of the signal strength measurements is below the average signal strength measurement threshold, repeating the method for an updated sector, wherein the updated sector is based on one or more of the signal strength measurements.

According to another embodiment, an UAV is disclosed. The UAV is used for positioning a radio antenna. The UAV comprises a processing circuitry and a memory, the memory containing instructions executable by the processing circuitry. The UAV is operative for: performing, while flying within a sector, at one or more positions, signal strength measurements of radio signal emitted from the radio antenna; if an average of the signal strength measurements is above an average signal strength measurement threshold, performing position measurements of the radio antenna; and if the average of the signal strength measurements is below the average signal strength measurement threshold, repeating performing the signal strength measurements for an updated sector, wherein the updated sector is based on one or more of the signal strength measurements.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic block diagram of a network arrangement in which the embodiments of the present invention may be used.

FIG. 2 is a flow chart illustrating a method performed by an UAV, according to possible embodiments.

FIG. 3 is a schematic diagram illustrating the method performed by the UAV, according to possible embodiments.

FIG. 4 is a block diagram illustrating the UAV in more detail, according to possible embodiments.

### DETAILED DESCRIPTION

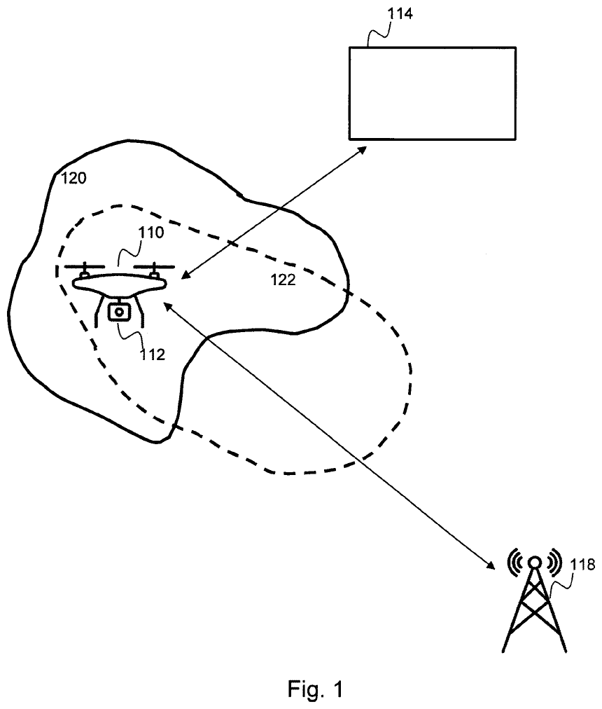

FIG. 1 shows a network arrangement according to an embodiment. A radio antenna 118 and an UAV 110 are shown in FIG. 1. The radio antenna 118 is arranged to emit and receive radio signals. In an embodiment, the UAV 110 is arranged to wirelessly communicate with the radio antenna 118. The UAV 110 is further arranged to wirelessly communicate with a network entity 114. The UAV 110 can fly in an area, measure signal strength of radio signals that are emitted from the radio antenna 118 and perform position measurements of the radio antenna 118 when flying in vicinity of the radio antenna 118.

A basic idea of this invention is that the UAV 110 firstly flies a sector 120 and measures one or more radio signal strength emitted from the radio antenna 118 when flying in the sector 120. The sector 120 is an area of any regular or irregular shape. An average of the radio signal strength measurements of the sector 120 are compared with an average signal strength measurement threshold. Because the radio signal strength measurement is higher when the UAV 110 is closer to the radio antenna 118, when the average of the signal strength measurements is above the average signal strength measurement threshold, it is determined that the UAV 110 is close enough to the radio antenna 118 and the UAV 110 performs position measurements in vicinity of the radio antenna 118. When the average of the signal strength measurements is below the average signal strength measurement threshold, it is determined that the UAV 110 is not close enough to the radio antenna 118, an updated sector 122 is determined. The updated sector 122 is also an area which can have any regular or irregular shape. The updated sector 122 is shown in dotted line to differentiate from the sector 120. The updated sector 122 is determined based on one or more signal strength measurements in the sector 120 and is closer to the radio antenna 118. Similar method is performed repeatedly in the updated sector 122 or even further updated sector, until the UAV 110 is close enough to the radio antenna 118 and performs position measurements in vicinity of the radio antenna 118.

Hereby, the UAV 110 automatically detects the direction of the radio antenna 118 by means of measuring signal strengths and flies towards to the radio antenna 118. When the UAV 110 is near to the radio antenna 118, the position measurements can be performed. Since the cost of the UAV 110 is low and the position measurements are performed near to the radio antenna 118, a cost-efficient, economic and accurate estimation of the radio antenna 118 position is achieved.

As discussed in the Background, the radio antenna 118 can be equipped on both network side equipment, such as base station, gNodeB, eNodeB, and UE of a wireless communication network. Furthermore, the radio antenna 118 can be equipped on other objects, e.g., vehicles, sensors, identification/positioning tags on physical objects, chips, infrastructures, etc. In general, the radio antenna 118 can be any radio antenna which is equipped on an object capable of radio communication.

The UAV 110 is an aircraft without any human pilot on board. Any kind of UAV is applicable in this invention, as long as it can perform radio signal strength measurement and position measurement. The UAV 110 may be equipped with a camera 112. For example, the UAV 110 can be a helicopter which streams video. In another example, the UAV 110 can be a search and rescue UAV. In a further example, the UAV 110 can be a parcel delivery UAV.

The network entity 114 may be a network side device of any kind of wireless communication network. Example of such wireless communication networks are Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE) Frequency Division Duplex (FDD) and Time Division Duplex (TDD), LTE Advanced, Wireless Local Area Networks (WLAN), Worldwide Interoperability for Microwave Access (WiMAX), WiMAX Advanced, as well as 5G wireless communication networks based on technology such as New Radio (NR), or even 6G. The network entity 114 may also be a network side device of any kind of wired communication network.

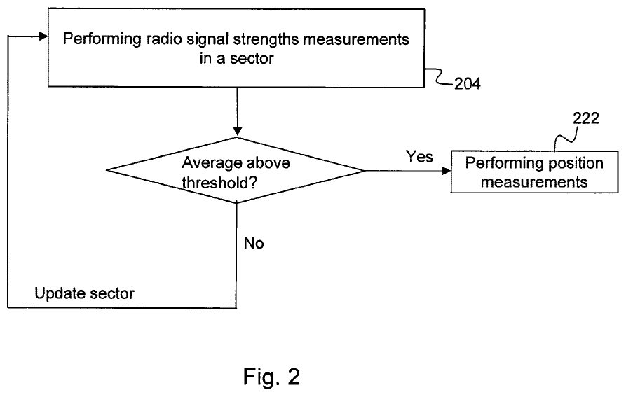

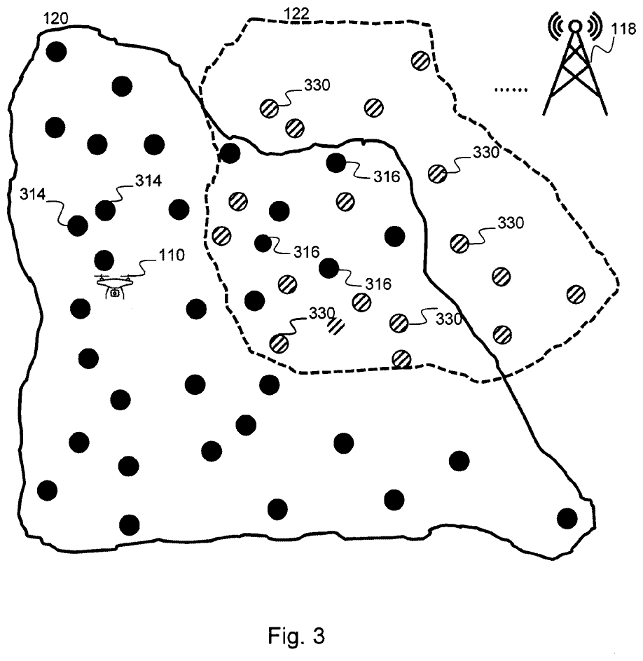

FIG. 2, in conjunction with FIG. 1 and FIG. 3, describes a method performed by an unmanned aerial vehicle, UAV 110. The method is used for positioning a radio antenna 118, the method comprises: performing 204, while flying 202 within a sector 120, at one or more positions, signal strength measurements 314, 316 of radio signal emitted from the radio antenna 118; if an average of the signal strength measurements 314, 316 is above an average signal strength measurement threshold, performing 222 position measurements of the radio antenna 118; and if the average of the signal strength measurements 314, 316 is below the average signal strength measurement threshold, repeating the method for an updated sector 122, wherein the updated sector 122 is based on one or more of the signal strength measurements 314, 316.

As shown in FIG. 1, a UAV 110 is operative for flying and measuring signal strength of the radio signals emitted from the radio antenna 118 in the sector 120.

In the step 204, while flying within the sector 120, the UAV 110 performs signal strength measurements of radio signal emitted from the radio antenna 118 at one or more positions. The number of measuring positions can be predefined. As discussed before, the sector 120 can be any regular or irregular shape. The signal strength measurements can be measurements of Reference Signal Receiving Power (RSRP), Received Signal Strength Indicator (RSSI), Received Signal Level (RSL), Reference Signal Received Power (RSRQ) or other indicators for signal strength. The flying height of the UAV 110 can be predefined and varied, e.g., 100 meters, depending on the area, environments, etc. The flying height can be fixed during the whole flight, and it is preferred to fly at a high altitude to avoid Non-line-of-sight (NLOS) situation in some scenarios. It is preferred to have many signal strength measurements to improve accuracy of the method.

In FIG. 3, the black dots 314 and 316 in the sector 120 schematically show the signal strength measurements performed by the UAV 110 in the sector 120. The difference between the signal strength measurements 314 and the signal strength measurements 316 is discussed in the following text.

In the step 222, when it is determined that an average of the signal strength measurements of the sector 120 is above an average signal strength measurement threshold, it indicates that the UAV 110 is in vicinity of the radio antenna 118. Optionally, it can be confirmed by the camera 112, that the camera 112 can detect the radio antenna 118 with its lens. The UAV 110 performs position measurements in vicinity of the radio antenna 118 and obtain one or more position measurements of the radio antenna 118. The position measurements can also be performed with the help of the camera 112. The details of the position measurements will be discussed in the following text.

If the average of the signal strength measurements 314, 316 is below the average signal strength measurement threshold, it indicates that the UAV 110 is still not close enough to the radio antenna 118 and needs to fly nearer to it. An updated sector 122 is defined based on the one or more of the signal strength measurements 314, 316 and the method is repeated in the updated sector 122. That is, when the updated sector 122 is defined, the UAV 110 performs signal strength measurements in the updated sector 122, and the average of the signal strength measurements in the updated sector 122 is compared to the average signal strength measurement threshold again. The method will be repeatedly performed, until the average of signal strength measurements of an updated sector is above the average signal strength measurement threshold, and the position measurements of the radio antenna 118 can be performed.

As shown in FIG. 3, the updated sector 122 can be any shape, and is shown via dotted line to differentiate from the sector 120.

By such an embodiment, the UAV 110 performs radio antenna 118 detection and position measurements automatically, independently and accurately.

According to another embodiment, wherein the updated sector 122 being based on one or more of the signal strength measurements 314, 316, further comprising: selecting one or more of the signal strength measurements 316 above a threshold; based on the positions of the one or more of the signal strength measurements 316 above the threshold, defining one or more new positions for the UAV 110, for performing 204 signal strength measurements 330.

When the signal strength measurements are performed in the sector 120 and one or more signal strength measurements 314, 316 are obtained, one or more signal strength measurements 316 above a threshold are selected. These selected signal strength measurements 316 indicate approximately the position of the radio antenna 118, i.e., these selected signal strength measurements 316 are nearer to the radio antenna 118 than other signal strength measurements 314. The threshold can be an absolute signal strength value, or a ratio threshold, e.g., top 25% of all the signal strength measurements of the sector 120, or the average of the signal strength measurements of the sector 120.

When the signal strength measurements 316 above the threshold are selected, one or more new positions are defined based on the positions of the selected signal strength measurements 316. The one or more new positions are in the updated sector 122 and the UAV 110 will perform signal strength measurements 330 on the new positions.

Referring to FIG. 3, the updated sector 122 is determined based on the selected signal strength measurements 316. New positions are defined in the updated sector 122, and the diagonal strips dots 330 indicate the signal strengths measurements on the new positions.

By such an embodiment, the updated sector 122 are defined by the signal strength measurements 316 which are higher than others. New measurement positions which are nearer to the radio antenna 118 are defined accordingly. Signal strength measurements 330 are performed on the new measurement positions.

According to another embodiment, the updated sector 122 is closer to the radio antenna 118 than the sector 120. That is to say, the updated sector 122 extends from the sector 120 in a direction in which the signal strength measurements increase. When the signal strength measurement increase, it indicates that the updated sector 122 is closer to the radio antenna than the sector 120.

As discussed above, the shape of the sector 120 and the updated sector 122 are not defined and may be any regular or irregular shape. The positions of signal strength measurements in the sector 120 or the updated sector 122 are not defined either, as long as the positions are within the sector 120 or the updated sector 122. As an example of implementation, the sector 120 may be a circle, and the positions of signal strength measurements within the sector 120 can be near the circumference of the circle. The updated sector 122 may be a sector shape or fan shape, which has the same center as the sector 120. By selecting the signal strength measurements which are above a threshold among the signal measurements near the circle circumference of the sector 120, a center angle is determined by the selected signal strength measurements. The sector/fan shape of the updated sector 122 has the same center as the circle of the sector 120, the center angle as determined by the selected signal strength measurements, and a radius which is longer than the circle of the sector 120. Therefore, the updated sector 122 is closer to the radio antenna 118 than the sector 120.

According to another embodiment, the method further comprises: estimating the radio antenna 118 position based on the position measurements.

The estimation of the radio antenna position based on the position measurements may have requirements on position measurements, e.g., minimum number of position measurements, etc.

By this embodiment, the UAV 110 performs the radio antenna 118 position estimation by itself.

According to another embodiment, the UAV 110 is arranged to wirelessly communicate with a network entity 114, and the method further comprises transmitting the position measurements to the network entity 114 for estimation of the radio antenna 118 position by the network entity 114.

In this embodiment, the UAV 110 transmits the position measurements to the network entity 114 and let the network entity 114 to perform the radio antenna 118 position estimation.

According to another embodiment, the estimating of the radio antenna 118 position further comprises: estimating the radio antenna 118 position based on the position measurements by a machine learning, ML, method using a ML model, wherein the ML method comprising a training phase followed by an inference phase, the training phase comprises: obtaining the data of the position measurements; preparing data for ML model based on the obtained data; receiving position of the radio antenna 118 as label; training the ML model based on the prepared data and received label; the inference phase comprises: obtaining the data of the position measurements; preparing data for ML model based on the obtained data; estimate the location of the radio antenna 118 based on prepared data, by running the trained ML model.

In this embodiment, the estimation of the radio antenna 118 position is performed by a ML method via a ML model. The ML method comprises two phases, training phase and inference phase. In the training phase, the ML model obtains the position measurements data as raw data. The raw data can be collected in a JavaScript Object Notation (JSON) format or other formats. The raw data comprises results of the position measurements performed by the UAV 110, and may further comprise UAV 110 identity, cell identity of the wireless communication network, radio antenna 118 identity, time, batch identity, UAV 110 position information, UAV 110 speed, UAV 110 direction, signal strength measurements, and/or doppler shift, etc. Alternatively, if multiple UAVs 110 are dispatched, it is possible to fuse the raw data from multiple UAVs 110. It is also possible to fuse raw data from other wireless communication network. Such raw data can be cell trace data, minimize drive test (MDT), etc.

When preparing data for ML model based on the obtained data, several pre-processing and transformation may be comprised in the preparation of data. According to one embodiment, outliers in raw data are managed. Statistical techniques are used to detect outliers in the raw data and the outliers are remedied, e.g., deleted or imputed. According to another embodiment, missing values of the raw data are handled: the raw data comprising missing value can be deleted, or using regression techniques or statistics of the remaining raw data to impute the raw data comprising missing value. According to another embodiment, row to column transformation is performed to the raw data: multiple rows in the raw data can be stacked column wise so that every row has enough information for estimating the radio antenna 118 position.

After data preparation, the known position of the radio antenna 118 is received by the ML model as label for training. The inputted label may comprise x, y, z position of the radio antenna 118. The inputted label may further comprise a class label, which classifies the position of the known radio antenna 118 into different grids. That is, the area where the radio antenna 118 being located is portioned into a number of grids, and the label indicates if the radio antenna 118 belongs to one grid or not.

When the data and the label are ready, the ML model is trained, so that a supervised ML method can be performed. The trained model is stored in a secure storage, e.g., as a pickle file.

After the ML model is trained, the inference phase can begin. The inference phase comprises obtaining the data of the position measurements and preparing data for ML model based on the obtained data. These two steps are similar to the training model. The inference phase also comprises estimating the position of the radio antenna 118 based on the prepared data, by running the trained model. Preferably, the input data to the ML model is a vector of position measurements which are collected in at least three distinct positions.

By this embodiment, an ML implementation is used when the UAV 110 estimates the position of the radio antenna 118.

When the radio antenna 118 estimation is performed by the network entity 114, a similar ML implementation can be utilized by the network entity 114.

According to another embodiment, the performed 222 position measurements around the radio antenna 118 are angle of arrival (AOA) measurements, time of arrival (TOA) measurements, round trip time (RTT) measurements, timing advance (TA) measurements performed on the radio signals emitted from the radio antenna, or any combination thereof.

The position measurements mentioned above are well-known position measurements which are widely used in the technical area of positioning. The UAV 110 flies around the radio antenna 118 and performs these position measurements.

When the radio antenna 118 is in a “sleeping” status and not emitting any radio antenna, the UAV 110 can only utilize its camera 112 to detect the radio antenna. Firstly, while flying, the UAV 110 uses the camera 112 to detect a large object on which the radio antenna 118 can be mounted, for example, a building, a tower, etc. When the larger object is detected, the UAV 110 flies towards the large object and attempts to detect the radio antenna 118 by the camera 112. When the radio antenna 118 is detected, the UAV 110 flies around it and performs position measurements.

Therefore, the UAV 110 can detect and measure the radio antenna 118 even when the radio antenna 118 is not emitting radio signal.

According to another embodiment, an UAV 110, for positioning a radio antenna 118 is disclosed. The UAV 110 comprises a processing circuitry 603 and a memory 604, the memory 604 containing instructions executable by the processing circuitry 603, whereby the UAV 110 is operative for: performing, while flying 202 within a sector 120, at one or more positions, signal strength measurements 314, 316 of radio signal emitted from the radio antenna 118; if an average of the signal strength measurements 314, 316 is above an average signal strength measurement threshold, performing position measurements of the radio antenna 118; and if the average of the signal strength measurements 314, 316 is below the average signal strength measurement threshold, repeating performing the signal strength measurements for an updated sector 122, wherein the updated sector 122 is based on one or more of the signal strength measurements 314, 316.

According to another embodiment, the updated sector 122 being based on one or more of the signal strength measurements 314, 316, further comprises: selecting one or more of the signal strength measurements 316 above a threshold; based on the positions of the one or more of the signal strength measurements 316 above the threshold, defining one or more new positions for the UAV 110, for performing 204 signal strength measurements 330.

According to another embodiment, the updated sector 122 is closer to the radio antenna 118 than the sector 120.

According to another embodiment, the UAV 110 is further operative for: estimating the radio antenna 118 position based on the position measurements.

According to another embodiment, the UAV 110 is arranged to wirelessly communicate with a network entity 114, the UAV 110 is further operative for: transmitting the position measurements to the network entity 114 for estimating of the radio antenna 118 position by the network entity 114.

According to another embodiment, the estimating of the radio antenna 118 position further comprises: estimating the radio antenna 118 position based on the position measurements by a machine learning, ML, method using a ML model, wherein the ML method comprising a training phase followed by an inference phase, wherein the training phase comprises: obtaining the data of the position measurements; preparing data for the ML model based on the obtained data; receiving position of the radio antenna 118 as a label; training the ML model based on the prepared data and the received label; wherein the inference phase comprises: obtaining the data of the position measurements; preparing data for the ML model based on the obtained data; estimating the position of the radio antenna 118 based on the prepared data, by running the trained ML model.

According to another embodiment, the performed position measurements of the radio antenna 118 are angle of arrival, AOA, measurements, time of arrival, TOA, measurements, round trip time, RTT, measurements, timing advance, TA, measurements performed on radio signals emitted from the radio antenna, or any combination thereof.

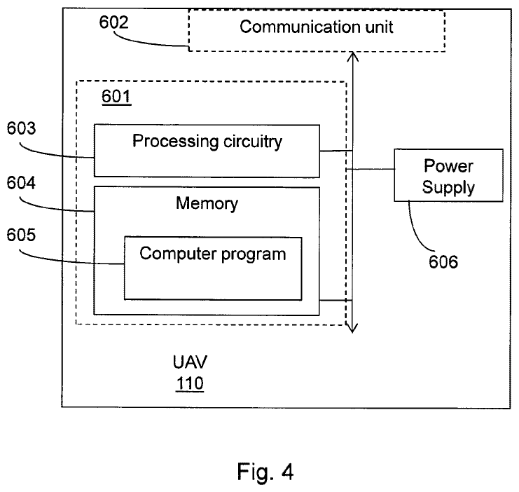

According to other embodiments, referring to FIG. 4, the UAV 110 may further comprise a communication unit 602, which may be considered to comprise conventional means for wireless communication with the network entity 114 and/or the radio antenna 118, such as a transceiver for wireless transmission and reception of signals. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions. The UAV 110 may also comprise a power supply, e.g., a battery.

The computer program 605 may be arranged such that when its instructions are run in the processing circuitry, they cause UAV 110 to perform the steps described in any of the described embodiments of the network entity 106 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the network entity 106 has access via the communication unit 602. The computer program 605 may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” Further, the term “a number of”, such as in “a number of wireless devices” signifies one or more devices. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by an unmanned aerial vehicle, UAV, the method being used for positioning a radio antenna, the method comprises:
performing, while flying within a sector, at one or more positions, signal strength measurements of radio signal emitted from the radio antenna,
if an average of the signal strength measurements is above an average signal strength measurement threshold, performing position measurements of the radio antenna; and
if the average of the signal strength measurements is below the average signal strength measurement threshold, repeating the method for an updated sector, wherein the updated sector is based on one or more of the signal strength measurements.

2. The method as claimed in claim 1, wherein the updated sector (being based on one or more of the signal strength measurements, further comprising:
selecting one or more of the signal strength measurements above a threshold;
based on the positions of the one or more of the signal strength measurements above the threshold, defining one or more new positions for the UAV, for performing signal strength measurements.

3. The method as claimed in claim 2, the updated sector is closer to the radio antenna than the sector.

4. The method as claimed in claim 1, the method further comprises:
estimating the radio antenna position based on the position measurements.

5. The method as claimed in claim 1, wherein the UAV is arranged to wirelessly communicate with a network entity, the method further comprises:
transmitting the position measurements to the network entity for estimating of the radio antenna position by the network entity.

6. The method as claimed in claim 4, wherein the estimating of the radio antenna position further comprises:
estimating the radio antenna position based on the position measurements by a machine learning, ML, method using a ML model, wherein the ML method comprises a training phase followed by an inference phase,
wherein the training phase comprises:
obtaining the data of the position measurements;
preparing data for the ML model based on the obtained data;
receiving position of the radio antenna as a label; and
training the ML model based on the prepared data and the received label; and
wherein the inference phase comprises:
obtaining the data of the position measurements;
preparing data for the ML model based on the obtained data; and
estimating the position of the radio antenna based on the prepared data, by running the trained ML model.

7. The method as claimed in claim 1, wherein the performed position measurements of the radio antenna are angle of arrival, AOA, measurements, time of arrival, TOA, measurements, round trip time, RTT, measurements, timing advance, TA, measurements performed on radio signals emitted from the radio antenna, or any combination thereof.

8. An unmanned aerial vehicle, UAV, for positioning a radio antenna, the UAV comprising a processing circuitry and a memory, the memory containing instructions executable by the processing circuitry, whereby the UAV is operative for:
performing, while flying within a sector, at one or more positions, signal strength measurements of radio signal emitted from the radio antenna;
if an average of the signal strength measurements is above an average signal strength measurement threshold, performing position measurements of the radio antenna; and
if the average of the signal strength measurements is below the average signal strength measurement threshold, repeating performing the signal strength measurements for an updated sector, wherein the updated sector is based on one or more of the signal strength measurements.

9. The UAV as claimed in claim 8, wherein the updated sector being based on one or more of the signal strength measurements, further comprises:
selecting one or more of the signal strength measurements above a threshold;
based on the positions of the one or more of the signal strength measurements above the threshold, defining one or more new positions for the UAV, for performing signal strength measurements.

10. The UAV as claimed in claim 9, wherein the updated sector is closer to the radio antenna than the sector.

11. The UAV as claimed in claim 8, wherein the UAV is further operative for:
estimating the radio antenna position based on the position measurements.

12. The UAV as claimed in claim 8, wherein the UAV is arranged to wirelessly communicate with a network entity, the UAV is further operative for:
transmitting the position measurements to the network entity for estimating of the radio antenna position by the network entity.

13. The UAV as claimed in claim 11, wherein the estimating of the radio antenna position further comprises:
estimating the radio antenna position based on the position measurements by a machine learning, ML, method using a ML model, wherein the ML method comprises a training phase followed by an inference phase,
wherein the training phase comprises:
obtaining the data of the position measurements;
preparing data for the ML model based on the obtained data;
receiving position of the radio antenna as a label; and
training the ML model based on the prepared data and the received label; and
wherein the inference phase comprises:
obtaining the data of the position measurements;
preparing data for the ML model based on the obtained data; and
estimating the position of the radio antenna based on the prepared data, by running the trained ML model.

14. The UAV as claimed in claim 8, wherein the performed position measurements of the radio antenna are angle of arrival, AOA, measurements, time of arrival, TOA, measurements, round trip time, RTT, measurements, timing advance, TA, measurements performed on radio signals emitted from the radio antenna, or any combination thereof.

15. A computer program product comprising instructions, which, when executed by a processing circuitry of an unmanned aerial vehicle, UAV, for positioning a radio antenna, causes the UAV to perform the following steps:
performing, while flying within a sector, at one or more positions, signal strength measurements of radio signal emitted from the radio antenna;
if an average of the signal strength measurements is above an average signal strength measurement threshold, performing position measurements of the radio antenna; and
if the average of the signal strength measurements is below the average signal strength measurement threshold, repeating performing the signal strength measurements for an updated sector, wherein the updated sector is based on one or more of the signal strength measurements.

16. (canceled)
